(19) United States
(12) Patent Application Publication
(10) Pub. No.: US 2007/0100785 A1
(43) Pub. Date: May 3, 2007

(54) Managing attributes in a digital information system

(76) Inventors: Herbert Hackmann, Wiesloch (DE); Ulrich Spinola, Weinheim (DE)

Correspondence Address: FISH & RICHARDSON, P.C., PO BOX 1022, MINNEAPOLIS, MN, 55440-1022, US

(21) Appl. No.: 11/264,560

(22) Filed: Nov. 1, 2005

(51) Int. Cl. G06F 17/30

(52) U.S. Cl. 707/1

(57) ABSTRACT

A computer-implemented method of configuring a distributed computing system may include receiving first configuration input identifying at least a first data object type and a first attribute of the first data object type. The distributed computing system may include multiple executable software applications, each of which may process data objects that are stored in a first database system and that have data object types, which may have attributes. The attributes may be stored in a second database system. The first configuration input may identify a first data object type and a first attribute. The first attribute may be registered in an attribute system that comprises the second database system. An association may be stored, in the attribute system, between the first data object type and the first attribute; during execution of an executable software application, the attribute system may provide a corresponding attribute value.

### TECHNICAL FIELD

This disclosure relates to managing attributes associated with data objects in a digital information system.

### BACKGROUND

Various entities may use digital information systems to manage information of all kinds. For example, a manufacturing company may use an enterprise resource planning (ERP) system to manage its inventory, manufacturing schedules, and product orders. The manufacturing company may use the same system to manage contact information, such as employee, customer and vendor information; accounting information, such as payroll, customer invoices and vendor payments; and sales information, such as completed sales, sales forecasts, region sales summaries, and so on. As another example, a group of physicians may use a digital information system to manage patient medical information. The patient medical information may include patient demographic information; scanned notes from physicians, taken during consultations with or examinations of the patient; lab results from any tests or analyses, such as tests of blood or tissue; images that may have been captured, such as x-rays, MRIs (magnetic resonance images), CAT scans (computer-aided tomography), and so. The group of physicians may also use the digital information system to track accounting information, such as payroll, patient invoices and payments, insurance invoices and payments, lab charges, and so on.

Digital information systems may be implemented on a single computer, or on a networked system of computers distributed throughout one building, several buildings, or buildings all over the world. The digital information system may include many different software components. The software components may be provided by a single company or by many different companies. Further, a digital information system may be implemented in various phases. For example, the software components may be designed and coded in a “design” phase. The software components may be integrated during a “configuration” phase of implementation. During the configuration phase, various components may be selected and configured to work together and within a specific system of computer hardware or within a specific network. Also during this configuration, various parameters of the software components may be set in order to implement a digital information system that implements the desired functions. For example, referring to the group of physicians described above, various generic, off-the-shelf ERP software components may be selected and configured, during a configuration phase, to work together and within the group's computer network to implement a system for managing patient medical information. During a “runtime” phase, programming code in the software components may be executed by one or more computer devices or systems to perform functions on the information within the system.

### SUMMARY

This disclosure relates to managing attributes associated with data objects in a digital information system. Digital information systems may track various pieces of information by creating and processing data objects. Some of the data objects may be stored in a data store or database, such as, for example, a relational database. Data objects may include both content and attributes. Content may include the information that is to be managed by the digital information system; an attribute may include a parameter that affects how the information is to be processed, or it may provide information about the primary information to be processed. For example, a data object in the physicians' digital information system may store an x-ray image. The x-ray image itself may be included in the content of the data object. An attribute associated with the data object may store information about the x-ray image, such as, for example, demographic information about the patient from whom the image was taken, demographic information about the lab technician who took the image, links to other related images, identification of a medical record with which the x-ray image is to be associated, and so on.

Metadata may also be stored in the digital information system. Metadata may include parameters that affect how attributes are to be processed. For example, metadata may affect how and when an attribute or other information is to be displayed. As another example, metadata may affect whether an attribute or other information is searchable. As another example, metadata may affect whether an attribute can be changed.

An attribute system may be used within a digital information system to create, register and manage attributes during a configuration phase. In some embodiments, the attribute system may also be used to create and manage metadata associated with the attributes.

In one general aspect, a computer-implemented method of configuring a distributed computing system may include receiving first configuration input identifying at least a first data object type and a first attribute of the first data object type. The distributed computing system may include multiple executable software applications, each of which may process data objects that are stored in a first database system. The data objects may have data object types, and the data object types may have attributes. The attributes may be stored in a second database system that is separate from the first database system. The first configuration input may identify at least a first data object type and a first attribute of the first data object type. The first attribute may be registered in an attribute system that comprises the second database system, if the first attribute has not previously been registered. An association may be stored, in the attribute system, between the first data object type and the first attribute so that during execution of a first executable software application that processes data objects having the first data object type, the attribute system provides to the first executable software application an attribute value corresponding to the first attribute.

In some embodiments, the first configuration input may further identify a first metadata element. The first metadata element may be registered in the attribute system, if the first metadata element has not previously been registered. Registering the first attribute or the first metadata element in the attribute system may include storing an identifier associated with the first attribute or the first metadata element in an index in the attribute system. The first configuration input may be user-actuated input received during a configuration phase of the distributed computing system.

In some embodiments, the computer-implemented method may further include storing, in the attribute system, an association between the first attribute and the first metadata element, so that during execution of the first executable software application, the attribute system further provides the first metadata element to the first executable software application. The first metadata element may configure a mode in which the distributed computing system processes the first attribute. The mode may specify a format for displaying the first attribute or may determine whether the first attribute is to be searchable.

In some embodiments, the computer-implemented method may further include receiving second configuration input identifying a second data object type and the first attribute, and storing an association in the attribute system between the second data object type, the first attribute and the first metadata element. The computer-implemented method may further include receiving third configuration input identifying the second data object type, the first attribute and a replacement metadata element. In some embodiments, the association between the second data object type, the first attribute and the first metadata element may be overwritten with an association between the second data object type, the first attribute and the replacement metadata element.

In some embodiments, the computer-implemented method may further include receiving additional configuration input that identifies a first data object having the first data object type and an attribute value to associate with the first attribute and the first data object. An association may be stored in the attribute system between the first attribute, the first data object and the first attribute value. In some embodiments, the association may be stored in the attribute system by storing an identifier corresponding to the first data object, the first attribute and the first attribute value in a row of a relational database table. The identifier may be a global unique identifier (GUID) in a relational database system.

In another general aspect, a computer-implemented method of accessing an attribute system in a distributed computing system may include receiving, during runtime, application input from an executable software application. The executable software application may be included in a distributed computing system that comprises multiple executable software applications, each of which may process data objects that are stored in a first database system. The data objects may have data object types, and the data object types may have attributes. The attributes may be stored in a second database system that is separate from the first database system. The application input may identify at least a first data object having a first data object type. The computer-implemented method may further include retrieving, from an attribute system, an attribute value corresponding to an attribute that is associated with the first data object and the first data object type. The computer-implemented method may further include providing the attribute value to the executable software application.

In some embodiments, the attribute may be associated with the first data object and with the first data object type by being stored in a row of a relational database table. The first data object type and an identifier corresponding to the first-data object may be stored in the same row of the relational database table. The attribute may be associated with the first data object type during a configuration time preceding the runtime of the distributed system.

The computer-implemented method may further include retrieving a metadata element from the attribute system that is associated with the attribute, and providing the metadata element to the executable software application. The metadata element may configure a mode in which the distributed computing system processes the attribute; the mode may specify a format for displaying the attribute or determine whether the attribute is to be searchable. Advantages of the systems and techniques described herein may include any or all of the following. Attributes may be flexibly created, registered or managed. Attributes may be created, registered or managed during a configuration phase of system implementation. Metadata may be flexibly managed. Metadata may be automatically applied to attributes.

The general and specific aspects may be implemented using a system, a method, or a computer program, or any combination of systems, methods, and computer programs. The details of one or more embodiments are set forth in the accompanying drawings and the description below. Other features, objects, and advantages will be apparent from the description and drawings, and from the claims.

### DESCRIPTION OF DRAWINGS

FIG. 1 is a diagram showing a physical arrangement of an exemplary environment in which an attribute system may be used, according to some embodiments.

FIG. 2 is a conceptual illustration of an exemplary information management system that may be used to manage information in an exemplary environment, according to some embodiments.

FIG. 3 is a block diagram of various components in an exemplary attribute system, according to some embodiments.

FIG. 4A is a diagram of an exemplary record that further illustrates attributes, attribute values and metadata that may be processed by an attribute system, according to some embodiments.

FIG. 4B is a diagram further illustrating the relationship between attributes, attribute values and metadata, according to some embodiments.

FIG. 4C is a diagram that illustrates exemplary repositories that may store various attributes, attribute values and metadata, according to some embodiments.

FIG. 5, comprising FIG. 5-1, FIG. 5-2 and FIG. 5-3, is a flow diagram illustrating exemplary actions that may be taken to use an attribute system in a digital information system, according to some embodiments.

FIG. 6 is a block diagram of an exemplary computer device, according to some embodiments.

Like reference symbols in the various drawings indicate like elements.

### DETAILED DESCRIPTION OF EXEMPLARY EMBODIMENTS

A digital information system may use the methods, systems and computer program products disclosed herein to manage attributes and metadata associated with data objects in the digital information system. More particularly, the methods, systems and computer products may enable a user to manage attributes and metadata during a configuration phase of implementing the digital information system.

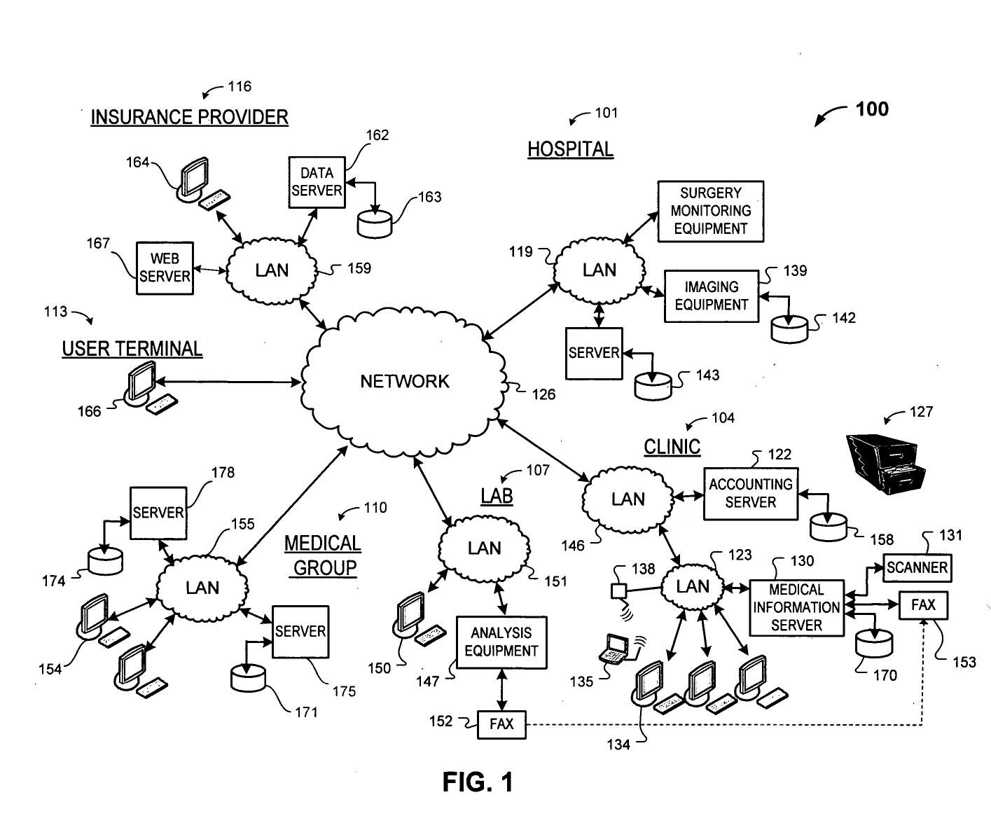

FIG. 1 is diagram showing a physical arrangement of an environment 100 in which an attribute system may be used. As shown, the exemplary environment 100 is a network of entities that may be associated with the provision of medical services. The system 100 includes a hospital 101, a clinic 104, a lab 107, a medical group 110, an insurance provider 116, and a user terminal 113. As will be described in more detail below, various kinds of information may be created and stored in different formats throughout the provision of medical services. For example, each kind of information may be represented by a data object of some kind. Each data object may hold various kinds of content, and various attributes may be associated with the data object and with different aspects of the data object's content. Metadata may be associated with some of the attributes. An exemplary environment in which information, documents, attributes and metadata are maintained is now described.

Various entities in the system 100 may maintain one or more local area networks (LANs). For example, the hospital may maintain a LAN 151; the clinic 104 may maintain one primary LAN 146 and a sub-network LAN 123; the lab 107 may maintain a LAN 151, and so on. The LANs of the various entities may connect to a central network 126. The central network 126 may be, for example, a private network, a metropolitan area network (MAN), or the Internet. Regardless of its exact type or topology, the network 126 may permit the various other entities to communicate with each other. Communication may take many forms. For example, the entities may communicate by electronic mail (email), with a file transfer protocol (FTP), or with a virtual private network (VPN). The content of the communication may be in any format, such as text, images, video, etc.

Within the exemplary environment 100, a patient may receive medical services to diagnose and treat a medical problem. For example, a patient may see his or her primary physician at the clinic 104. The primary physician may initially examine the patient in an examining room. The examining room may be equipped with a computer terminal through which the primary physician can access at least some of the patient's medical records for review or to add new medical information. Medical records for the patient may be stored in paper files 127, or in digital format on a medical information server 130. In some embodiments, clinic personnel may use a scanner 131 to import paper files 127 into the medical information server 130, such that they are accessible from the computer terminal in the examining room. The computer terminal may be, for example, a hardwired computer terminal 134 that is connected to a network 123. As another example, the computer terminal may be a wireless device 135 that accesses the medical information server 130 through a wireless access point 138 and the network 123. Based on the initial examination, the primary physician may order further testing for the patient. For example, the primary physician may determine that further diagnosis requires various magnetic resonance images (MRIs) and a blood test. These procedures may be carried out at the hospital.

At the hospital, the patient may have the MRIs taken on MRI imaging equipment 139. The images may be taken and stored in a digital format. They may be stored in a storage device 142 that is connected to or integrated with the imaging equipment 139, or the images may be stored in another storage device, such as networked storage 143 that is accessible through the local network 119 that is maintained by the hospital. The MRIs may be interpreted at the hospital, for example, by a radiology department. The MRIs may also be provided to the doctor. For example, the MRIs may be electronically transmitted to the medical information server 130 at the clinic, via the hospital's LAN 119, the central network 126, and the clinic's LANs 122 and 123. From the medical information server 130, the doctor may view the MRIs.

The patient may also have blood drawn at the hospital in order for it to be tested. The blood may be analyzed at the hospital, or it may be transported to a lab for analysis, such as the lab 107. To analyze the blood at the lab 107, technicians may use analysis equipment 147. Results of the analysis may be stored on a computer 150 that is connected to the lab's LAN 151. The results may also be sent to the primary physician. For example, the results may be sent electronically, via the lab's LAN 151, the central network 126, and the clinic's networks 146 and 123. Or, the results may be sent by facsimile, via fax machines 152 and 153. Subsequently, the results may be stored in the medical information server 130 and viewed by the primary physician.

In the course of diagnosis and treatment, other physicians may review the patient's medical records. For example, the primary physician may be part of a medical practice group (graphically depicted as the medical group 110). Another physician, such as a reviewing physician in the medical practice group, may review the patient's medical records, for example, from the computer terminal 154. More particularly, the reviewing physician may access the patient's medical records that are stored in the medical information server 130, via the medical group's LAN 155, the central network 126, and the networks 146 and 123 of the clinic.

Each of the medical services provided in the course of diagnosis and treatment may be billed. Various systems may be involved in the billing and payment process. For example, each entity may maintain its own billing system. The billing system of the clinic 104, for example, may include an accounting server 122 and an accounting database 158. Various paper records may also be maintained in paper files 127 for billing purposes. If the patient has health insurance, the services may be initially billed to an insurance provider, such as, for example, the insurance provider 116. As shown, the insurance provider has its own LAN 159, data server 162 and data storage facility 163. The data server 162 may electronically receive bills from the clinic 104, via the various intervening networks. The bills may be reviewed and approved by insurance provider personnel using, for example, a terminal 164.

Information about the various bills received by the insurance provider 116, or about the status of the approval or payment process for those bills, may be available to other users connected to the central network 126. For example, the patient, using a user terminal 166, may be able to access a web server 167 to view approval status of the patient's various bills. Similarly, accounting personnel at the clinic 104 may be able to access this same information via the various networks.

To manage the myriad of information associated with providing medical services to patients, the medical group 110 may utilize a digital information management system (“information management system”). The digital information management system may take many forms. In some embodiments, it may include various modules and components that are installed and executed by different devices in the environment 100. For example, an exemplary digital information management system may include components in one or more databases, such as the databases 158, 170, 171, and 174; various servers, such as the servers 122, 130, 175, 178; and various display terminals, such as the terminals 134, 135, and 154. An exemplary digital information management system may include various components that allow it to communicate over various networks, such as the LANs 155, 146 and 123, and over the central network 126. Further, the digital information management system may include components that enable it to securely connect to, and exchange information with, various other systems, such the systems of the lab 107, the hospital 101, the insurance provider 116, and the user terminal 113.

The information management system may be provided by a single software provider, or it may be a complex amalgamation of components from various software providers. Moreover, the information management system may be implemented in various stages. Various exemplary stages of implementing the information management system are now described.

In some embodiments, the first stage of implementation of an information management system may include initial design of the components. That is, the function of the components vis-à-vis other components in an overall operating environment may be defined in a planning or “design stage.” In this design stage, the processing steps a component is to perform may be defined, as well as any interfaces the component is to provide, and parameters that the component is to receive as input or provide as output. In some embodiments, this design information may be captured in a design document.

In some embodiments, a second stage of implementation may be a “coding stage,” in which individual components may be implemented in actual programming code. At this stage, the programming code may be an intermediate programming code. For example, the programming code may be high-level code like ABAP, C++, or Java that must be compiled or interpreted prior to being able to cause a processor to perform particular tasks, which, together, may implement a function or method.

In some embodiments, a third stage of implementation may be a “configuration stage,” in which various components may be configured and integrated to form a specific information management system. For example, a software provider, such as SAP AQ, may provide various information management system components that can be used to implement information management systems for any industry, company or organization. In the configuration stage, the various components may be configured and integrated to implement a specific information management system on specific hardware devices. By way of example, various components such as SAP Web Application Server, SAP Enterprise Portal, SAP Master Data Management, SAP Visual Composer and SAP Solution Manager may be integrated and configured to provide an information management system for the exemplary system 100.

In some embodiments, a fourth stage may be “runtime,” during which the various configured components cause one or more computer processors to execute instructions that implement various aspects of the information management system. For example, in a runtime stage of the exemplary system 100 described above, a reviewing physician may access a patient's medical records that are stored in various devices throughout a physical network.

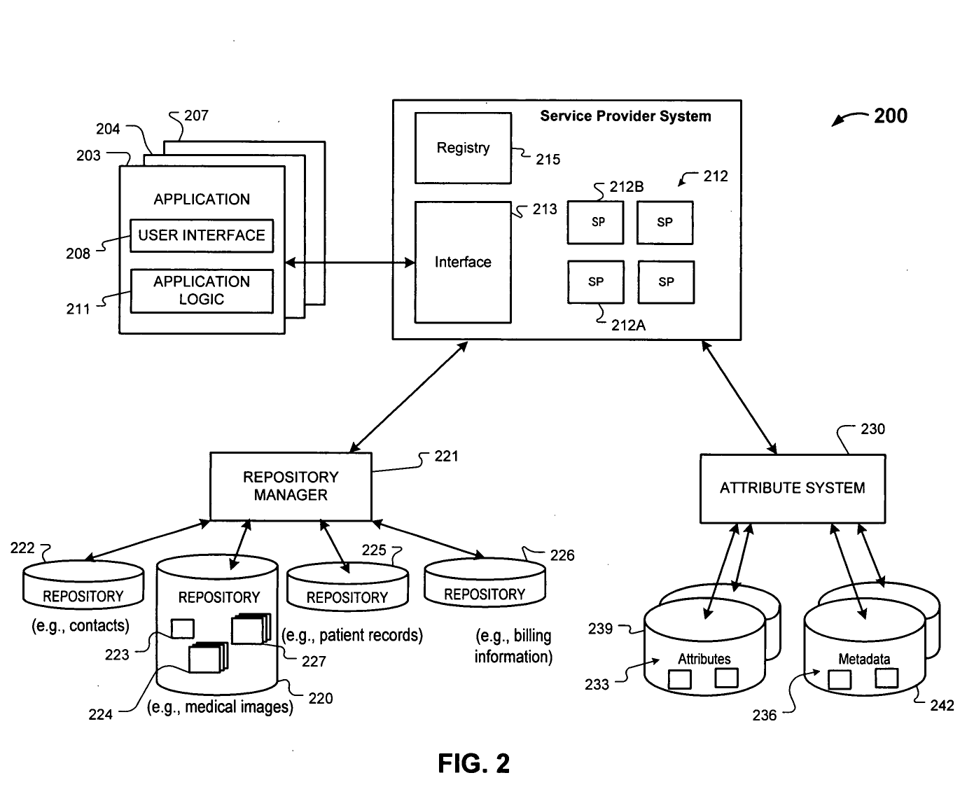

FIG. 2 is a conceptual illustration of an exemplary information management system 200 that may be used to manage information in an exemplary environment, such as that shown in FIG. 1. The information management system 200 may include various applications 203, 204 and 207, each of which may perform a different task within the system 200. By way of example, one application may process medical images, such as MRIs. Another application may process contact information, such as patient demographic and billing information, and physician demographic and employment information. Another application may interface with a scanner to scan and store paper copies of patient medical records or billing documents. In some embodiments, each application may include a user interface 208 and application logic 211.

The user interface may provide output to a user and receive input from the user. For example, the user interface 208 portion of the application 203 may cause graphical information to be presented on the display of a computer terminal, such as, for example, the computer terminal 154. Output may be presented in other ways, as well. For example, the user interface 208 may control a printer device or cause a file to be stored in a storage device, such as, for example, the networked database 171.

The application logic 211 may control internal access to and transformation of information within the information management system 200. For example, the application logic 211 may include programming code that is executed in part by the server 175. The application logic, through execution of the programming code, may cause information to be retrieved from a database, such as a patient medical record from the medical information server 130 and corresponding database 158. Through the user interface 208, the retrieved information may be displayed on a computer terminal, such as the computer terminal 154. A reviewing physician may view the patient medical records and make changes or additions to it. The user interface 208 may receive the changes or additions, and the application logic may save these changes or additions to the patient medical record in the medical information server 130.

To perform various tasks, both the user interface 208 and the application logic 211 may use service provider (SPs), such as the service providers 212. A service provider may include a module of programming code that performs a particular function or provides a particular interface. For example, in some embodiments, the service provider may be implemented in an object-oriented computer programming language, and the service provider may include one or more object-oriented classes that may be used to process a particular kind of data object. More particularly, one service provider, or set of service providers, may employ programming code that implements a first set of object-oriented classes to process MRI image data; another service provider, or set of service providers, may employ programming code that implements a second set of object-oriented classes to process billing documents or other accounting information. Service providers may allow an application to divide various tasks into smaller subtasks that may be performed by reusable, parameterized portions of code.

The service providers 212 may be registered in and accessed through a service provider system 219. The service provider system 219 may provide an interface 213 between the service providers 212 and the user interface 208 or the application logic 211. Such an interface 213 may facilitate an efficient design, coding, configuration, and runtime process by providing an important layer of abstraction. More particularly, the interface 213 may receive input that identifies a particular task to perform, such as, for example, to “retrieve the MRI record having identifier 718974 for display.” In some embodiments, the task may inherently identify, at a programming code level, one or more object-oriented classes that are able to execute the task. Based on the object-oriented classes that are able to execute the task, the interface 213 may identify one or more service providers (e.g., service provider 212A) that implements the identified object-oriented classes, and the interface 213 may further pass to the identified service provider 212A any parameters necessary to execute the task (e.g., “MRI record 718974”). After the identified service provider 212A executes the task, the interface 213 may return any data or output to the user interface 208 or to the application logic 211. For example, in the scenario described above involving retrieving an MRI record, the service provider 214 may perform “back-end” tasks, such as, for example, navigating any networks between the computer executing the application 203 and the medical images repository 220, where the MRI record may be stored; authenticating the access of the medical images repository 220; and actually retrieving and copying data associated with the relevant MRI record. The interface 213 may provide this retrieved data to the application 203.

In this manner, application developers may be able to develop applications 203, 204 or 207 to interact with the service provider system 219 and with that system's interface 213, rather than with individual service providers. Similarly, service provider developers may develop service providers 212 to interact with relevant back-end components and with the interface 213, rather than with individual applications 203, 204 or 207. That is, the service provider system 219 may provide a standard interface that facilitates efficient development of service providers and applications.

In some embodiments, each service provider may be designed in a “design stage,” and coded in a “coding stage” by a different software provider. One software provider, for example, may design and code a service provider to provide an interface to a particular database or repository. Another software provider may design and code another service provider to provide certain input/output functionality in a digital information system. In a “configuration stage,” the various service providers may be integrated into a single system. Integration within the system may involve registering the service providers with the service provider system 219. For example, in some embodiments, service providers may be registered in a registry 215. More particularly, in some embodiments, a list or description of the object-oriented classes each service provider implements may be registered in the registry 215. The interface 213 may then use the registry 215 to identify one or more service providers that implement a desired set of object-oriented classes.

As described above, in some embodiments, the service provider framework may cause an appropriate service provider to be called or executed at runtime in order to provide desired functionality. In these embodiments, service providers may be added or replaced through registration or removal from the service provider framework. Thus, the service provider framework may provide a runtime interface between service providers and other parts of the system.

The information management system 200 may also employ a repository manager 221. In some embodiments, the repository manager 221 may provide a standardized interface to various repositories, such as the repositories 220, 222, 225 and 226, and various service providers may access the various repositories through the repository manager 221. Some embodiments may omit the repository manager 221, and the service providers may interface directly with the various repositories.

The information management system 200 may also employ an attribute system 230 to manage various attributes 233 and metadata 236 associated with information in the information management system 200. The attributes 223 may be stored in one or more attribute repositories 239, and the metadata 236 may be stored in one or more metadata repositories 242. The metadata may include parameters that affect how attributes are to be processed or displayed. In some embodiments, service providers, such as the service providers 212, may access the attribute system 230 to retrieve attributes and metadata associated with data objects that may be stored in other repositories, such as the repositories 220, 222, 225 and 226. In some embodiments, in order to process a data object, a service provider (e.g., service provider 212A) may access a data repository (e.g., data repository 220), an attribute repository (e.g., attribute repository 239) and a metadata repository (e.g., metadata repository 242).

By way of example, the repository 220 may store medical images for the exemplary system 100. More particularly, the repository 220 may store MRI images, for example, in the form of MRI records, that correspond to specific patients. Various aspects of an MRI record may be captured in an MRI record type 223. More particularly, the MRI record type 223 may serve as a template that characterizes the attributes and content to be stored in instances 224 of the MRI record type 223, which may be stored as MRI records 224. In some embodiments, attributes may specify, for example, particular fields that each MRI record is to have, such as fields for a patient's name associated with the MRI images in the MRI record. Other attributes may specify other patient demographic information or other information, such as information about the technician who captured corresponding MRI images, or information about the machine used to capture the images.

Metadata may be used to configure certain aspects of the attributes. For example, metadata may specify a type of data for each attribute value corresponding to an attribute. A type of data may be, for example, an integer, or a string or a linked list. Other metadata may indicate, for example, whether an attribute is to be searchable. Other metadata may indicate, for example, how an attribute and corresponding attribute value should be displayed. More particularly, the metadata may specify a color, or a font size, or a position where attributes and attribute values should be displayed.

A single repository, such as the repository 220, may be physically implemented in more than one databases or storage devices. Referring back to the exemplary system 100 that is shown in FIG. 1, the repository 220 may be implemented by the databases 142, 143 and 170. In some embodiments, MRI image 227 may be stored separately from the MRI records 224 and linked to the MRI records 224 in some manner. In other embodiments, MRI images 227 may be stored with the MRI records 224. More particularly, MRI images 227 may be stored in either of the databases 143 or 142. The MRI record type 223 and MRI records 224 may be stored in the database 170.

When a reviewing physician uses the computer terminal 179 to view an MRI record 224, the information system 200 may access the MRI record type 223 to determine which attributes to display. The information system 200 may also access specific MRI records, for example the MRI record 224. The information system 200 may also access other information sources to retrieve, for example, MRI images to display in the MRI record 224. To further illustrate record types, records, attributes, attribute values, and metadata, an exemplary attribute system is described followed by a description of an exemplary record.

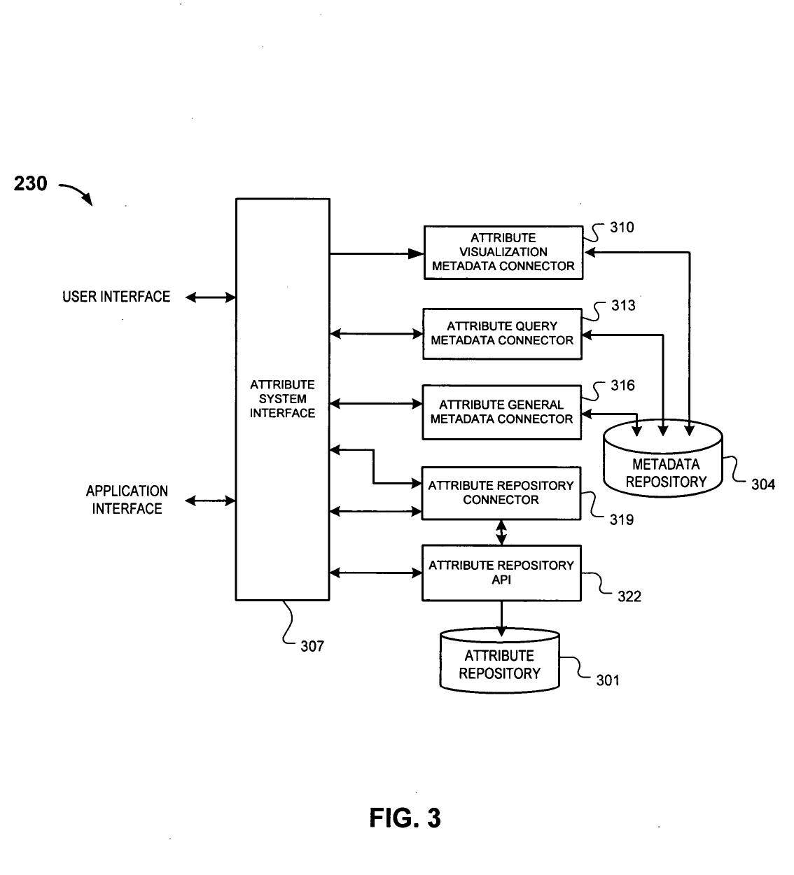

FIG. 3 is a block diagram of various components in an exemplary attribute system 230, according to some embodiments. The attribute system may include an attribute repository 301, a metadata repository 304, and an attribute system interface 307.

The attribute repository 301 may store attributes and associations between attributes and data objects or data object types. In some embodiments, the attribute repository 301 may also store attribute values and corresponding associations among attribute values, attributes, data object types and data object instances. In some embodiments, attribute values may be stored separately from attributes.

The metadata repository 304 may store metadata and associations between metadata and attributes. In some embodiments, the metadata repository 304 and the attribute repository 301 may be included in the same logical data structure, such as a relational database table. In some embodiments, the metadata repository 304 and the attribute repository 301 may be physically and logically distinct.

The attribute system interface 307 may provide a standardized interface to the attribute repository 301 and the metadata repository for applications and for user interfaces. For example, the attribute system interface 307 may provide a standardized interface for the application logic 211 in the application 203 that is shown in FIG. 2. As another example, the attribute system interface 307 may provide a standardized interface for the user interface 208 in the same application. In some embodiments, all processing of attributes and metadata may occur through the attribute system interface 307.

The attribute system 230 may employ various connectors and service providers to provide the interface. For example, a different connector may provide an interface for each type of metadata supported in a system. Some embodiments may include at least three types of metadata: one type of metadata may configure how attributes and other information are to be displayed; another type of metadata may configure how searching is to be performed on attributes and attribute values; and a third type of metadata may configure general parameters associated with attributes or attribute values, such as, for example, the type of data (e.g., string, integer, etc.) that characterizes the attribute or attribute value. Some embodiments may support other types of metadata. As shown, one connector 310 may process metadata that is related to displaying (or “visualizing”) information. Another connector 313 may process metadata that is related to searching. Another connector 316 may process general-parameter metadata.

The attribute system 230 may employ other connectors and interfaces. For example, the attribute system 230 may include a connector 319 for interfacing with the attribute repository 301. The attribute system 230 may also include an application programming interface (API) 322 for interfacing with the attribute repository 301. In some embodiments, a user interface, such as the user interface 208, may use the connector 319, while application logic, such as the application logic 211, may use the API 322.

In some embodiments, a connector or an API is a module of programming code that performs a particular function or implements a particular interface. In some embodiments, a connector may be implemented by a service provider. Or, a service provider may provide one or more connectors or APIs. For example, the connectors 310, 313 and 316 may be implemented by the service provider 212B, and the API may be implemented by the service provider 212A. In some embodiments, the attribute system 230 may operate conjunction with a service provider system, such as the service provider system 219. For example, at runtime, the service provider system 219 may provide functionality that is logically depicted by the connector 310.

As shown, the attribute system interface 307 is shown separately from the various connectors described above. However, in some embodiments, the various connectors may be included within the attribute system interface 307. Moreover, only a few exemplary connectors are shown. An attribute system may include other connectors. For example, an attribute system may include various connectors for processing specific types of attributes. As another example, the attribute system may include an API associated with the metadata repository.

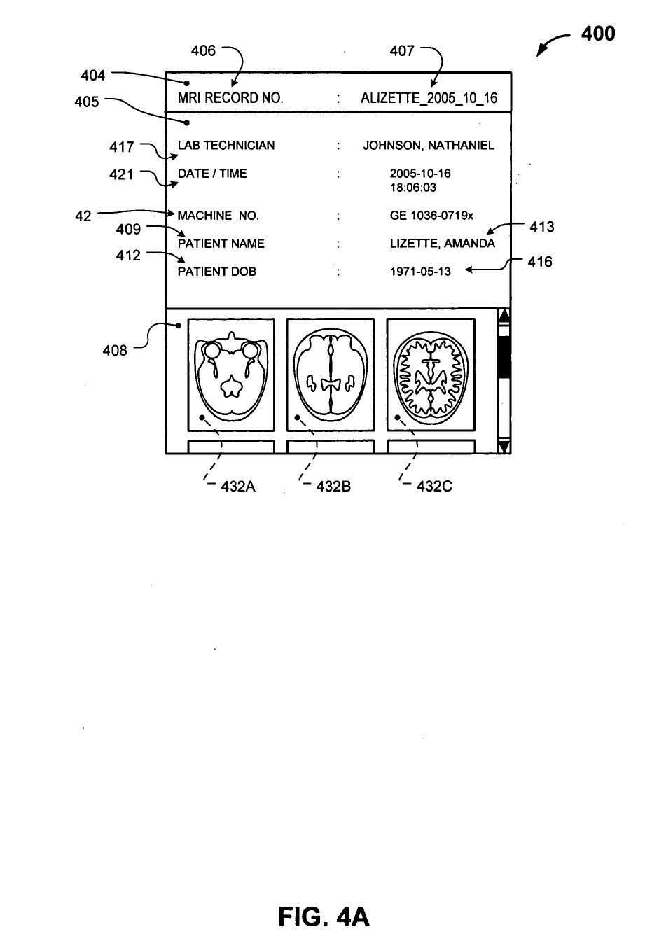

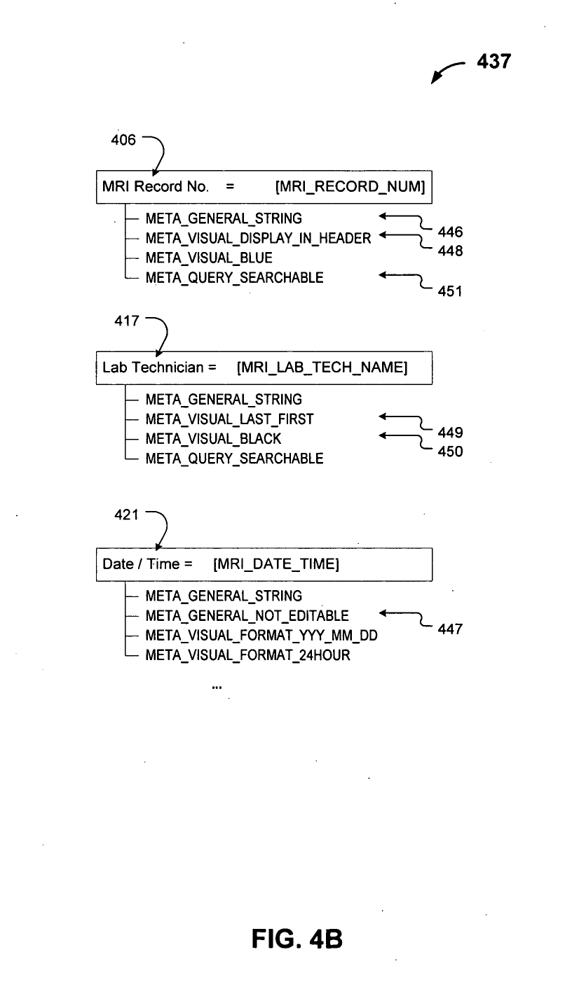

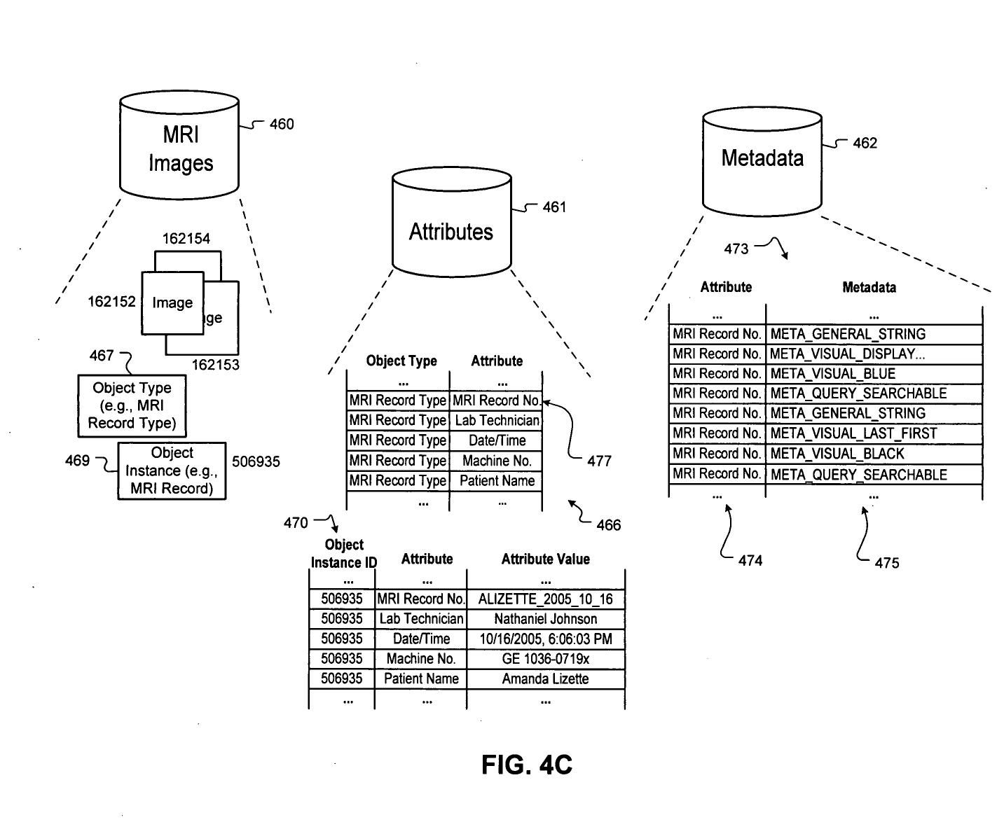

FIG. 4A is a diagram of an exemplary record 400 that further illustrates attributes, attribute values and metadata that may be processed by an attribute system. As shown, FIG. 4 is an MRI record 400 having three sections: a header section 404, a section for demographic information 405, and a section for displaying images 408. Various attributes and attribute values may provide information within the MRI record. For example the MRI record may include a patient's name attribute 409, and a patient date-of-birth attribute 412. Associated with the attributes may be attribute values, including an attribute value 413 for the patient's name 409 and an attribute value 416 for the patient's date of birth 412. Other information regarding the images displayed in the MRI record may also be included. For example the MRI record may include an attribute 417 for a lab technician who took the MRI images, a date and time attribute 421 corresponding to when the images were taken, and a machine identifier attribute 428 indicating the machine with which the images were taken. Attributes or attribute values that identify the images themselves may also be stored within the MRI record. For example, attribute values 432A, 432B, and 432C may identify the specific images shown in the exemplary MRI record 400. In some embodiments, attribute values that identify a corresponding medical record may be stored with the images.

Various metadata may be associated with the attributes shown in the exemplary MRI record 400. For example metadata associated with the overall record (not shown) may identify the various sections of the record (the header, the section for demographic information and the section for images). Metadata for the record as a whole may further configure the images to be displayed within a pane.

FIG. 4B is a diagram further illustrating the relationship between attributes, attribute values and metadata. More particularly, FIG. 4B shows a portion of a record type 437, of which the MRI record 400 may be an instance. Record types may include attributes and corresponding metadata that are to be included in instances of the record type. As shown, the portion of the record type 437 includes two attributes: the MRI Record attribute 406, and the Lab Technician attribute 417. Other attributes, which are not shown, may also be included. For example, all of the attributes that are shown in the MRI Record 400 may be included. The record type 437 may further include placeholders 440 and 443 for values of the attributes 406 and 417, respectively. The placeholders may indicate attribute values that are to be stored in instances of the record type, rather than in the record type itself.

Each attribute may be associated with metadata. Metadata may serve many purposes. In some embodiments, metadata may be of a general nature. For example, general metadata may specify a data type of an attribute value, such as a string specified by a metadata element 446. General metadata may also prevent some action from being taken on an attribute. For example, metadata element 447 may specify that the corresponding attribute is not to be editable. Such a metadata element 447 may protect the integrity of certain data that should not be changed. Metadata elements may also specify how attributes or attribute value are to be displayed. For example, the metadata elements 448, 449 and 450 may specify, respectively, where an attribute value is to be displayed, a format the attribute value is to have, or a color in which the attribute value is to be displayed. Metadata elements may also specify whether an attribute or attribute value is to be searchable. For example, the metadata element 451 may indicate that the MRI Record attribute 406 and its corresponding attribute value are to be searchable. In some embodiments, this may cause this attribute and attribute value to be indexed in a database table, for example. Metadata may serve other purposes, and the purposes describe above are for illustration only. Metadata may be associated with an attribute or a larger entity. For example metadata may apply to an entire document, record or portion of the document or record.

In some embodiments, attributes, attribute values and metadata may be stored in separate locations. For example, the attributes and metadata may be stored with a record type, and the attribute values may be stored with record instances. Referring to FIG. 2, various attributes may be stored, in some embodiments, with the MRI record type 223. In some embodiments, attributes 233, such as the attributes 406, 417 and 421, maybe stored in an attribute repository 239 associated with an attribute system 230. Attribute values may be stored with MRI record instances 224. Similarly, metadata 236, such as the metadata elements 446, 448 and 451, may be stored in the metadata repository 242.

In some embodiments, metadata may be stored separately from attributes or attribute values. For example in some embodiments metadata 456 may be stored in a repository 457 associated with an attribute system 445. Storage of attributes, attribute values and metadata is now further illustrated with reference to FIG. 4C.

FIG. 4C illustrates exemplary repositories 460, 461, and 464 that may store various attributes, attribute values and metadata. The attribute repository 461 may include a table 466 that associates an object type with various attributes. As shown, the object type may correspond to an MRI Record Type, other portions of which may be stored in another repository, such as the repository 460, or in the service provider system 219. The table 466 may associate various attributes with the object type specified. When instances of the object type are created, they may have each of the attributes listed in the table 466. In some embodiments, tables, such as the 466, may be relational database tables, and associations, for example, between an object type and an attribute, may be made by made by storing the object type and the attribute in the same row in the database table.

The attribute repository 461 may further include a table 470 that stores attribute values for the various attributes associated with specific instances of an object type. As shown, the table 470 includes attribute values for the object instance 469 (e.g., an MRI record corresponding to the record 400 that is shown in FIG. 4A).

Another repository 462 may store metadata for various attributes. As shown, the repository 462 includes a table that associates attributes 474 with metadata elements475. These attributes 474 and metadata elements 475 correspond to the attributes and metadata elements that are shown in FIG. 4B.

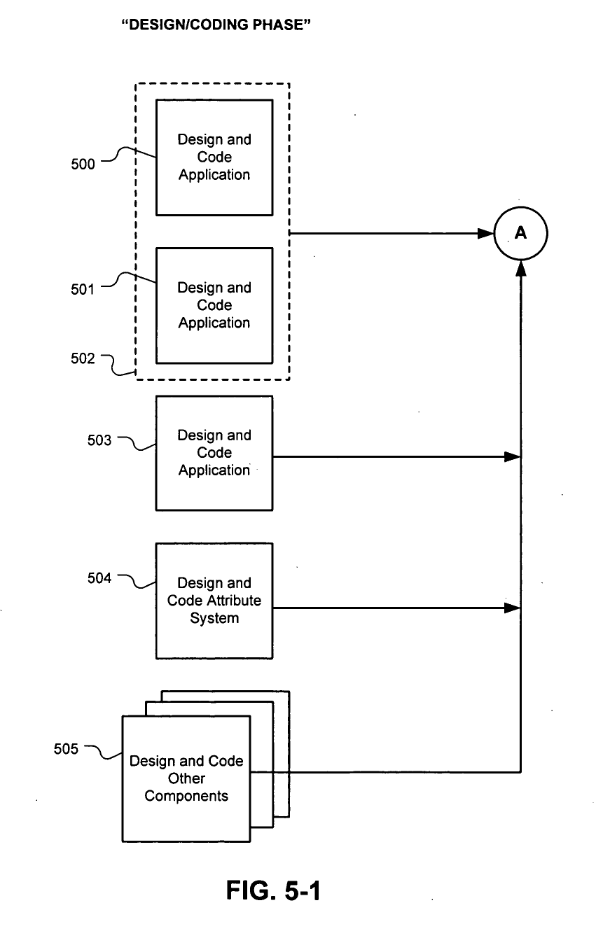

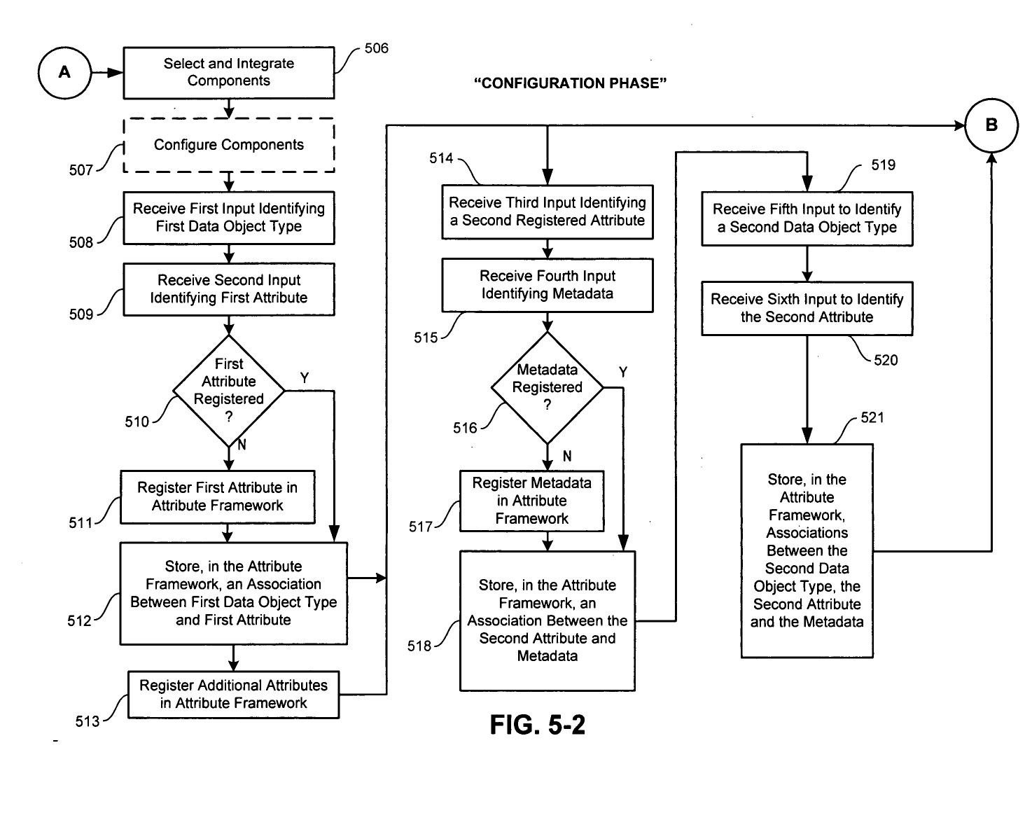

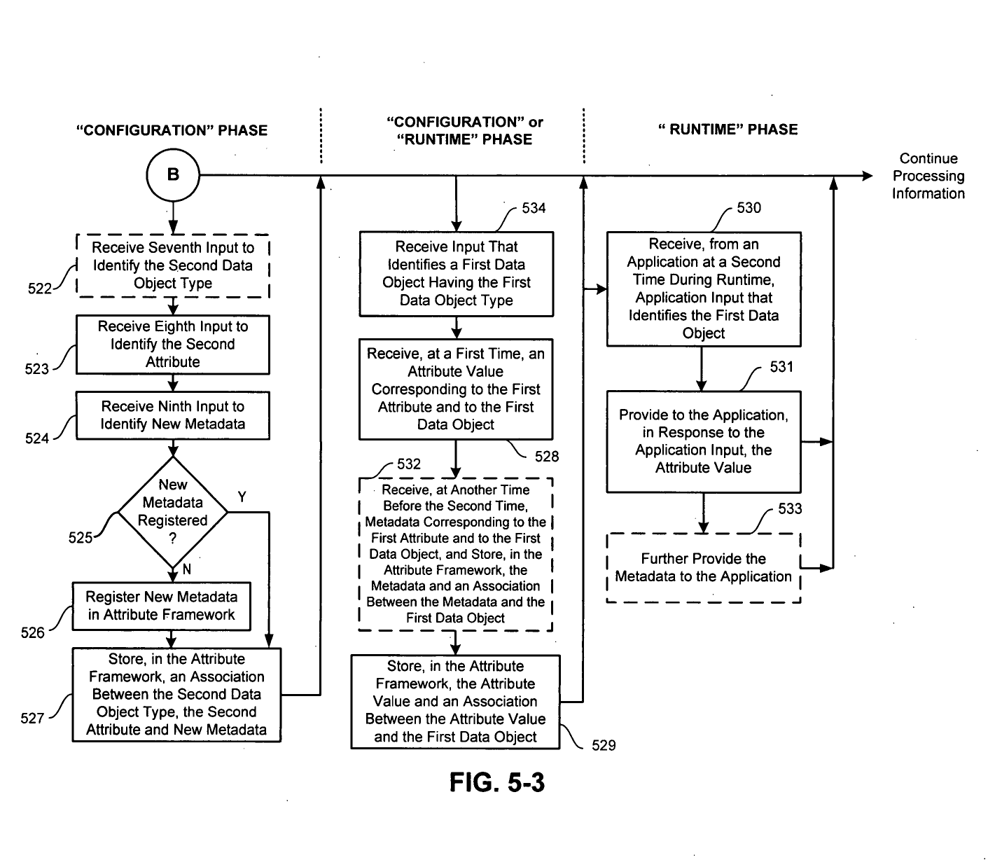

FIGS. 5-1, 5-2 and 5-3 together comprise a flow diagram illustrating various actions that may be taken to use an attribute system in a digital information system. As previously described, a digital information system may be implemented in various phases, such as a design/coding phase, a configuration phase, and a runtime phase. As shown in FIG. 5-1, various components of the digital information system may be designed and coded in the design/coding phase. For example, an application 500 may be designed and coded during the design/coding phase. Another application 501 may also be designed and implemented in the design phase. The applications 500 and 501 may be part of a package 502. For example, a software provider may provide a software package that includes more than one application. Another software provider may design and code another application 503. An attribute system component 504 may also be designed and coded in the design/coding phase. Various other components 505 that may be incorporated into a digital information system may also be designed and coded or otherwise implemented during the design phase.

Referring now to FIG. 5-2 the various components 500 to 505 may be selected and integrated (506) during a “configuration” phase. The components may include application components and a component that implements an attribute system. Optionally, various components may be configured (507). After the components are integrated to form, for example, a specific digital information system, various parameters associated with one or more of the components may require configuration. For example, some components may require specification of a particular file path for a database. As another example, various user terminals and other computer devices that are part of the digital information system may require configuration (507). The reader will appreciate that various aspects of a digital information system are typically configured during a configuration phase.

In addition to configuring the various components of the digital information system, various data structures may also be configured during the configuration phase. For example, in operation, the digital information system may process data of various types. During the configuration phase, each data type may be defined by a data structure in the digital information system.

During the configuration phase, the digital information system may receive (508) first input (e.g., from an engineer configuring the system) identifying a first data object type. Various data object types may include attributes that describe instances of the data object types. Further, various metadata may be associated with one or more of the attributes. As previously described, the metadata may describe how an attribute is to be processed.

The digital information system may receive (509) second input identifying a first attribute. The system may determine (510) whether the first attribute has already been registered in an attribute system. If the first attribute has not been registered, the system may register (511) the first attribute in the attribute system. The system may then store (512), in the attribute system, an association between the first data object type and the first attribute. Referring to FIG. 4C, this action (512) may correspond to storing the object type identifier “MRI Record Type” in table 466 along with the attribute identifier “MRI Record No.” Additional attributes may also be registered (513) in the attribute system. The system may receive (514) third input identifying a second registered attribute. The system may receive (515) forth input identifying metadata. The system may determine (516) whether the metadata has been registered in the attribute system. If the metadata has not been registered, the system may register (517) the metadata in the attribute system. The system may also store (518) in the attribute system, an association between the second attribute and the metadata. Referring to FIG. 4C, this action (518) may correspond to storing attributes and metadata elements in the table 473.

In some embodiments, the system may receive (519) fifth input to identify a second data object type. A sixth input may be received (520) that identifies the second, previously identified attribute. In some embodiments, this may be the same second attribute that was identified (514) by the third input. The system may store (521) in the attribute system associations between the second data object type, second attribute, and the metadata. More particularly, because the second attribute was previously associated (518) with metadata, any additional associations of that second attribute and a new data object type may result in an automatic association of the metadata with the new data object type when the attribute is associated with the new data object type.

In some embodiments, the automatic association of metadata, the attribute and the new data object type may be modified. For example, the system may receive (522) seventh input to identify the second data object type. The system may receive (523) eighth input to identify the second attribute. The system may receive (524) ninth input to identify new metadata. The system may determine (525) whether the new metadata has been registered in the attribute system. If the new metadata has not been registered, the system may register (526) the new metadata in the attribute system. Then, the system may store (527), in the attribute system, associations between the second data object type, the second attribute, and the new metadata.

In some embodiments, the attribute system may provide attribute or metadata information to an application during runtime. Further, the attribute system may provide to the application an attribute value or metadata for the attribute. The attribute value may have been stored in the attribute system during a configuration time, or previously during runtime, or the attribute value may be generated for temporary use by the application at runtime. In either case, the system may receive (534), during configuration time or runtime, input that identifies a first data object having the first data object type. That is, the system may receive input that identifies an instance of the first data object type. Referring to FIG. 4C, the system may receive input from an application identifying the object instance 469. The instance (first data object) may have been created by the system during runtime, or the instance (first data object) may have been previously stored within the system. The system may receive (528), at a first time, an attribute value corresponding to the first attribute and to the first data object. For example referring to FIG. 4A and FIG. 4C, the system may receive input that specifies a value 413 for a patient name to associate with the MRI Record instance 469. The system may store (529), in the attribute system the attribute value, and an association between the attribute value and the first data object. For example, the system may store the attribute value 413 in the table 470.

At a second time, during runtime, the system may receive (530) from an application, application input that identifies the first data object. In response to the application input, the system may provide (531) to the application, the attribute value. For example, referring to FIG. 3, an application may query the attribute system 230 for an attribute value; the attribute system interface 307 may receive the query; it may retrieve a corresponding attribute value with the API 322, from the attribute repository 301; and the attribute system interface 307 may convey the retrieved attribute value to the application.

Metadata may also be associated with the first attribute, and in some embodiments the metadata may also be provided to the application. For example the system may receive (532) at another time (before the second time), metadata corresponding to the first attribute and to the first data object. The system may store (532), in the attribute system the metadata and an association between the metadata and the first data object. Further, the system may provide (533) the metadata to the application.

In a similar manner as described with respect to actions 528 to 533, the system may receive from and provide to a user interface various attributes, attribute values, and metadata. For example, a user may employ a user interface to input, display and store attributes, attribute values and metadata.

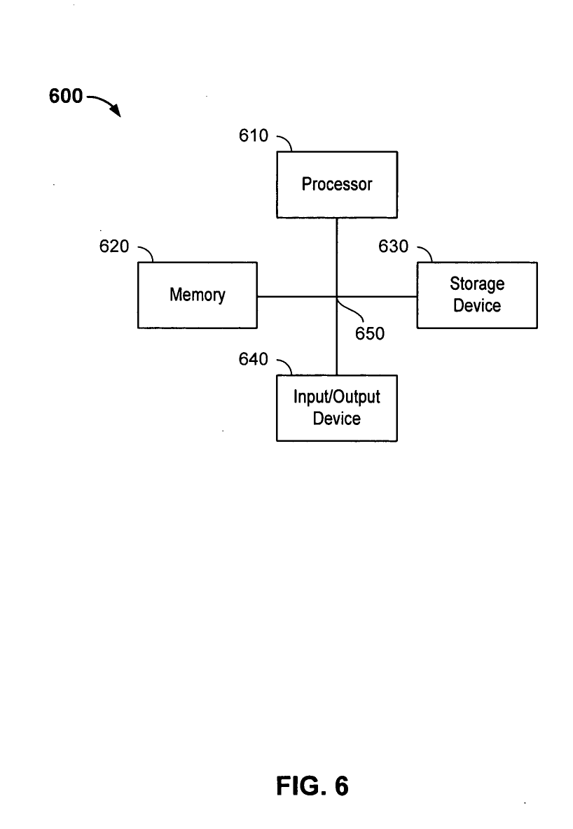

FIG. 6 is a block diagram of a computer device 600 that may be used in the operations described above, according to some embodiments. The computer device 600 includes a processor 610, a memory 620, a storage device 630 and an input/output device 740. Each of the components 610, 620, 630 and 640 are interconnected using a system bus 650.

The processor 610 is capable of processing instructions for execution within the computer device 600. In some embodiments, the processor 610 is a single-threaded processor. In other embodiments, the processor 610 is a multi-threaded processor. The processor 610 is capable of processing instructions stored in the memory 620 or on the storage device 630 to display graphical information for a user interface on the input/output device 640.

The memory 620 stores information within the computer device 600. In some embodiments, the memory 620 is a computer-readable medium. In some embodiments, the memory 620 is a volatile memory unit. In some embodiments, the memory 620 is a non-volatile memory unit.

The storage device 630 is capable of providing mass storage for the computer device 600. In some embodiments, the storage device 630 is a computer-readable medium. In various other embodiments, the storage device 630 may be a floppy disk device, a hard disk device, an optical disk device, or a tape device.

The input/output device 640 provides input/output operations for the computer device 600. In some embodiments, the input/output device 640 includes a keyboard and/or pointing device. In some embodiments, the input/output device 640 includes a display unit for displaying graphical user interfaces.

The method may be implemented in digital electronic circuitry, or in computer hardware, firmware, software, or in combinations of them. Apparatus may be implemented in a computer program product tangibly embodied in an information carrier, e.g., in a machine-readable storage device or in a propagated signal, for execution by a programmable processor; and actions of the method may be performed by a programmable processor executing a program of instructions to perform functions of the invention by operating on input data and generating output. Embodiments may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language, including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer may include a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, a computer device may include a display device such as a CRT (cathode ray tube) or LCD (liquid crystal display) monitor for displaying information to the user and a keyboard and a pointing device such as a mouse or a trackball by which the user may provide input to the computer.

Apparatus and methods disclosed herein may be implemented in a computer system that includes a back-end component, such as a data server; or that includes a middleware component, such as an application server or an Internet server; or that includes a front-end component, such as a client computer having a graphical user interface or an Internet browser, or any combination of them. The components of the system may be connected by any form or medium of digital data communication such as a communication network. Examples of communication networks include, e.g., a LAN, a WAN, and the computers and networks forming the Internet.

The computer system may include clients and servers. A client and server are generally remote from each other and typically interact through a network, such as the described one. The relationship of client and server may arise by virtue of computer programs running on the respective computers and having a client-server relationship to each other.

Embodiments may include, at least in part, in hardware or software or in any combination thereof Hardware may include, for example, analog, digital or mixed-signal circuitry, including discrete components, integrated circuits (ICs), or application-specific ICs (ASICs). Embodiments may also be implemented, in whole or in part, in software or firmware, which may cooperate with hardware. Processors for executing instructions may retrieve instructions from a data storage medium, such as EPROM, EEPROM, NVRAM, ROM, RAM, a CD-ROM, a HDD, and the like. Computer program products may include storage media that contain program instructions for implementing embodiments described herein.

A number of embodiments have been described. Nevertheless, it will be understood that various modifications may be made without departing from the spirit and scope of this disclosure. Accordingly, other embodiments are within the scope of the following claims.

What is claimed is:

1. A computer-implemented method of configuring a distributed computing system comprising:
receiving first configuration input in a distributed computing system that comprises multiple executable software applications, each of which processes data objects that are stored in a first database system, the data objects having data object types, the data object types having attributes, the attributes being stored in a second database system that is separate from the first database system, the first configuration input identifying at least a first data object type and a first attribute of the first data object type;
registering the first attribute in an attribute system that comprises the second database system, if the first attribute has not previously been registered; and
storing, in the attribute system, an association between the first data object type and the first attribute so that during execution of a first executable software application that processes data objects having the first data object type, the attribute system provides to the first executable software application an attribute value corresponding to the first attribute.

2. The computer-implemented method of claim 1, wherein the first configuration input further identifies a first metadata element.

3. The computer-implemented method of claim 2, further comprising registering the first metadata element in the attribute system, if the first metadata element has not previously been registered.

4. The computer-implemented method of claim 3, further comprising storing, in the attribute system, an association between the first attribute and the first metadata element, so that during execution of the first executable software application, the attribute system further provides the first metadata element to the first executable software application.

5. The computer-implemented method of claim 4, wherein the first metadata element configures a mode in which the distributed computing system processes the first attribute, wherein the mode specifies a format for displaying the first attribute or determines whether the first attribute is to be searchable.

6. The computer-implemented method of claim 4, further comprising receiving second configuration input identifying a second data object type and the first attribute, and storing an association in the attribute system between the second data object type, the first attribute and the first metadata element.

7. The computer-implemented method of claim 6, further comprising receiving third configuration input identifying the second data object type, the first attribute and a replacement metadata element.

8. The computer-implemented method of claim 7, further comprising overwriting the association between the second data object type, the first attribute and the first metadata element with an association between the second data object type, the first attribute and the replacement metadata element.

9. The computer-implemented method of claim 3, wherein registering the first attribute or the first metadata element in the attribute system comprises storing an identifier associated with the first attribute or the first metadata element in an index in the attribute system.

10. The computer-implemented method of claim 1, further comprising receiving second configuration input that identifies a first data object having the first data object type and an attribute value to associate with the first attribute and the first data object.

11. The computer-implemented method of claim 10, further comprising storing, in the attribute system, an association between the first attribute, the first data object and the first attribute value.

12. The computer-implemented method of claim 11, wherein the association is stored in the attribute system by storing an identifier corresponding to the first data object, the first attribute and the first attribute value in a row of a relational database table.

13. The computer-implemented method of claim 12, wherein the identifier is a global unique identifier (GUID) in a relational database system.

14. The computer-implemented method of claim 1, wherein the first configuration input is user-actuated input received during a configuration phase of the distributed computing system.

15. A computer-implemented method of accessing an attribute system in a distributed computing system, the method comprising:
receiving, during runtime, application input from an executable software application in a distributed computing system that comprises multiple executable software applications, each of which processes data objects that are stored in a first database system, the data objects having data object types, the data object types having attributes, the attributes being stored in a second database system that is separate from the first database system, the application input identifying at least a first data object having a first data object type;
retrieving, from an attribute system, an attribute value corresponding to an attribute that is associated with the first data object and the first data object type; and
providing the attribute value to the executable software application.

16. The computer-implemented method of claim 15, wherein the attribute is associated with the first data object and with the first data object type by being stored in a row of a relational database table, the first data object type and an identifier corresponding to the first data object being stored in the same row of the relational database table.

17. The computer-implemented method of claim 15, further comprising retrieving a metadata element from the attribute system that is associated with the attribute, and providing the metadata element to the executable software application.

18. The computer-implemented method of claim 17, wherein the metadata element configures a mode in which the distributed computing system processes the attribute, wherein the mode specifies a format for displaying the attribute or determines whether the attribute is to be searchable.

19. The computer-implemented method of claim 15, wherein the attribute is associated with the first data object type during a configuration time preceding the runtime of the distributed system.

20. A computer program product, tangibly embodied in an information carrier, the computer program product comprising instructions that, when executed, cause a processor to perform operations comprising:
receiving first configuration input in a distributed computing system that comprises multiple executable software applications, each of which processes data objects that are stored in a first database system, the data objects having data object types, the data object types having attributes, the attributes being stored in a second database system that is separate from the first database system, the first configuration input identifying at least a first data object type and a first attribute that characterizes the first data object type;
registering the first attribute in an attribute system that comprises the second database system, if the first attribute has not previously been registered; and
storing, in the attribute system, an association between the first data object type and the first attribute so that during execution of a first executable software application that processes data objects having the first data object type, the attribute system provides to the first executable software application an attribute value corresponding to the first attribute.
